(19) United States
(12) Patent Application Publication
(10) Pub. No.: US 2026/0052417 A1
(43) Pub. Date: Feb. 19, 2026

(54) MEASUREMENT METHOD, DEVICE AND STORAGE

(71) Applicant: BEIJING XIAOMI MOBILE SOFTWARE CO., LTD., Beijing (CN)

(72) Inventor: Yajun ZHU, Beijing (CN)

(21) Appl. No.: 19/101,851

(22) PCT Filed: Aug. 8, 2022
(86) PCT No.: PCT/CN2022/110954

§ 371 Date: Feb. 6, 2025

(51) Int. Cl. H04W 24/10; H04W 24/02; H04W 56/00

(52) U.S. Cl. CPC H04W 24/10; H04W 24/02; H04W 56/001; H04W 56/0045

(57) ABSTRACT

A measurement method, a communication device and a storage medium are provided. The measurement method is performed by a first terminal device, and includes: obtaining indication information, wherein the indication information is used to determine a timing deviation between the first terminal device and a second terminal device; and measuring a reference signal sent by the second terminal device based on the timing deviation.

### CROSS-REFERENCE TO RELATED APPLICATION

The present application is a U.S. National Stage of International Application No. PCT/CN2022/110954, filed on Aug. 8, 2022, the contents of all of which are incorporated herein by reference in their entireties for all purposes.

### BACKGROUND

In a dynamic time division duplex (TDD) scenario, a base station will dynamically adjust the TDD uplink and downlink configuration to better adapt to service transmission, which causes cross interference between uplink and downlink transmissions in different cells. For the cross interference problem between terminal devices, the degree of cross interference between terminal devices may be determined by measuring the reference signal of the interfering terminal by the terminal device.

### SUMMARY

The present disclosure relates to the field of mobile communication technology, and in particular to a measurement method and a measurement device.

In a first aspect, an embodiment of the present disclosure provides a measurement method, which is performed by a first terminal device, and the method includes:
obtaining indication information, in which the indication information is used to determine a timing deviation between the first terminal device and a second terminal device;
measuring a reference signal sent by the second terminal device based on the timing deviation.

In a second aspect, an embodiment of the present disclosure provides another measurement method, which is performed by an access network device or a second terminal device, and the method includes:
sending indication information to a first terminal device;
in which the indication information is used by the first terminal device to determine a timing deviation between the first terminal device and the second terminal device, and to measure a reference signal sent by the second terminal device based on the timing deviation.

In a third aspect, an embodiment of the present disclosure provides another measurement method, which is performed by a second terminal device, and the method includes:
obtaining indication information, in which the indication information is used to determine a timing deviation between the second terminal device and a first terminal device;
sending a reference signal based on the timing deviation, in which the reference signal is used for the first terminal to perform measurement.

In a fourth aspect, an embodiment of the present disclosure provides another measurement method, which is performed by an access network device or a first terminal device, and the method includes:
sending indication information to a second terminal device;
in which the indication information is used by the second terminal device to determine a timing deviation between the second terminal device and the first terminal device, and to send a reference signal based on the timing deviation, in which the reference signal is used by the first terminal device for measurement.

In a fifth aspect, an embodiment of the present disclosure provides a measurement device, which is executed by a first terminal device, and the device includes:
an obtaining module, configured to obtain indication information, in which the indication information is used to determine a timing deviation between the first terminal device and a second terminal device;
a measurement module, configured to measure a reference signal sent by the second terminal device based on the timing deviation.

In a sixth aspect, an embodiment of the present disclosure provides a measurement device, which is performed by an access network device or a second terminal device, and the device includes:
a sending module, configured to send indication information to a first terminal device;
in which the indication information is used by the first terminal device to determine a timing deviation between the first terminal device and the second terminal device, and to measure a reference signal sent by the second terminal device based on the timing deviation.

In a seventh aspect, an embodiment of the present disclosure provides a measurement device, which is executed by a second terminal device, and the device includes:
an obtaining module, configured to obtain indication information, in which the indication information is used to determine a timing deviation between the second terminal device and a first terminal device;
a sending module, configured to send a reference signal based on the timing deviation, in which the reference signal is used for the first terminal to perform measurement.

In an eighth aspect, an embodiment of the present disclosure provides a measurement device, which is performed by an access network device or a first terminal device, and the device includes:
a sending module, configured to send indication information to a second terminal device;
in which the indication information is used by the second terminal device to determine a timing deviation between the second terminal device and the first terminal device, and to send a reference signal based on the timing deviation, in which the reference signal is used for the first terminal device to perform measurement.

In a ninth aspect, an embodiment of the present disclosure provides a communication device, including a processor and a memory, in which the memory stores a computer program, and the processor executes the computer program stored in the memory to perform the method described in the first aspect above.

In a tenth aspect, an embodiment of the present disclosure provides a communication device, including a processor and a memory, in which the memory stores a computer program, and the processor executes the computer program stored in the memory to perform the method described in the second aspect above.

In an eleventh aspect, an embodiment of the present disclosure provides a communication device, including a processor and a memory, in which the memory stores a computer program, and the processor executes the computer program stored in the memory to perform the method described in the third aspect above.

In a twelfth aspect, an embodiment of the present disclosure provides a communication device, including a processor and a memory, in which the memory stores a computer program, and the processor executes the computer program stored in the memory to perform the method described in the fourth aspect above.

In a thirteenth aspect, an embodiment of the present disclosure provides a communication device, which includes a processor and an interface circuit, the interface circuit is used to receive code instructions and transmit the code instructions to the processor, and the processor is used to run the code instructions to enable the device to execute the method described in the first aspect above.

In a fourteenth aspect, an embodiment of the present disclosure provides a communication device, which includes a processor and an interface circuit, the interface circuit is used to receive code instructions and transmit the code instructions to the processor, and the processor is used to run the code instructions to enable the device to execute the method described in the second aspect above.

In a fifteenth aspect, an embodiment of the present disclosure provides a communication device, which includes a processor and an interface circuit, the interface circuit is used to receive code instructions and transmit the code instructions to the processor, and the processor is used to run the code instructions to enable the device to execute the method described in the third aspect above.

In a sixteenth aspect, an embodiment of the present disclosure provides a communication device, which includes a processor and an interface circuit, the interface circuit is used to receive code instructions and transmit the code instructions to the processor, and the processor is used to run the code instructions to enable the device to execute the method described in the fourth aspect above.

In a seventeenth aspect, an embodiment of the present disclosure provides a measurement system, which includes the measurement device described in the fifth aspect, the measurement device described in the sixth aspect, the measurement device described in the seventh aspect, and the measurement device described in the eighth aspect, or the system includes the communication device described in the ninth aspect, the communication device described in the tenth aspect, the communication device described in the eleventh aspect, and the communication device described in the twelfth aspect, or the system includes the communication device described in the thirteenth aspect, the communication device described in the fourteenth aspect, the communication device described in the fifteenth aspect, and the communication device described in the sixteenth aspect.

In an eighteenth aspect, an embodiment of the present invention provides a computer readable storage medium for storing instructions for the first terminal device. When the instructions are executed, the first terminal device executes the method described in the first aspect.

In a nineteenth aspect, an embodiment of the present invention provides a computer readable storage medium for storing instructions for the access network device or the second terminal device. When the instructions are executed, the access network device or the second terminal device executes the method described in the second aspect.

In a twentieth aspect, an embodiment of the present invention provides a computer readable storage medium for storing instructions for the second terminal device. When the instructions are executed, the access network device or the second terminal device executes the method described in the third aspect.

In the twenty first aspect, an embodiment of the present invention provides a computer readable storage medium for storing instructions for the access network device or the first terminal device. When the instructions are executed, the access network device or the second terminal device executes the method described in the fourth aspect.

In the twenty second aspect, the present disclosure also provides a computer program product including a computer program, when the computer program is executed on a computer, enables the computer to execute the method described in the first aspect above.

In the twenty third aspect, the present disclosure also provides a computer program product including a computer program, when the computer program is executed on a computer, enables the computer to execute the method described in the second aspect above.

In the twenty fourth aspect, the present disclosure also provides a computer program product including a computer program, when the computer program is executed on a computer, enables the computer to execute the method described in the third aspect above.

In the twenty fifth aspect, the present disclosure also provides a computer program product including a computer program, when the computer program is executed on a computer, enables the computer to execute the method described in the fourth aspect above.

In a twenty sixth aspect, the present disclosure provides a chip system, which includes at least one processor and an interface, for supporting a first terminal device to implement the functions in the first aspect, for example, determining or processing at least one of the data and information in the above method. In one possible design, the chip system also includes a memory, which is used to store computer programs and data necessary for the terminal device. The chip system can be composed of a chip, or it can include a chip and other discrete devices.

In a twenty seventh aspect, the present disclosure provides a chip system, which includes at least one processor and an interface, for supporting a first terminal device to implement the functions in the second aspect, for example, determining or processing at least one of the data and information in the above method. In one possible design, the chip system also includes a memory, which is used to store computer programs and data necessary for the terminal device. The chip system can be composed of a chip, or it can include a chip and other discrete devices.

In a twenty eighth aspect, the present disclosure provides a chip system, which includes at least one processor and an interface, for supporting a first terminal device to implement the functions in the third aspect, for example, determining or processing at least one of the data and information in the above method. In one possible design, the chip system also includes a memory, which is used to store computer programs and data necessary for the terminal device. The chip system can be composed of a chip, or it can include a chip and other discrete devices.

In the twenty ninth aspect, the present disclosure provides a chip system, which includes at least one processor and an interface, for supporting a first terminal device to implement the functions in the fourth aspect, for example, determining or processing at least one of the data and information in the above method. In one possible design, the chip system also includes a memory, which is used to store computer programs and data necessary for the terminal device. The chip system can be composed of a chip, or it can include a chip and other discrete devices.

In the thirtieth aspect, the present disclosure provides a computer program, when the computer program is executed on a computer, enables the computer to execute the method described in the first aspect above.

In the thirty first aspect, the present disclosure provides a computer program, when the computer program is executed on a computer, enables the computer to execute the method described in the second aspect above.

In the thirty second aspect, the present disclosure provides a computer program, when the computer program is executed on a computer, enables the computer to execute the method described in the third aspect.

In the thirty third aspect, the present disclosure provides a computer program, when the computer program is executed on a computer, enables the computer to execute the method described in the fourth aspect above.

### BRIEF DESCRIPTION OF THE DRAWINGS

In order to more clearly illustrate the technical solutions in the embodiments of the present disclosure or the background, the drawings in the embodiments of the present disclosure or the background will be described below.

FIG. 1 is a schematic diagram of a communication system provided in an embodiment of the present disclosure;

FIG. 2 is a flow chart illustrating a measurement method provided in an embodiment of the present disclosure;

FIG. 3 is a flow chart illustrating a measurement method provided in an embodiment of the present disclosure;

FIG. 4 is a flow chart illustrating a measurement method provided in an embodiment of the present disclosure;

FIG. 5 is a flow chart illustrating a measurement method provided in an embodiment of the present disclosure;

FIG. 6 is a flow chart illustrating a measurement method provided in an embodiment of the present disclosure;

FIG. 7 is a flow chart illustrating a measurement method provided in an embodiment of the present disclosure;

FIG. 8 is a flow chart illustrating a measurement method provided in an embodiment of the present disclosure;

FIG. 9 is a flow chart illustrating a measurement method provided in an embodiment of the present disclosure;

FIG. 10 is a flow chart illustrating a measurement method provided in an embodiment of the present disclosure;

FIG. 11 is a flow chart illustrating a measurement method provided in an embodiment of the present disclosure;

FIG. 12 is a flow chart illustrating a measurement method provided in an embodiment of the present disclosure;

FIG. 13 is a schematic diagram of a measurement device provided in an embodiment of the present disclosure;

FIG. 14 is a schematic diagram of a measurement device provided in an embodiment of the present disclosure;

FIG. 15 is a schematic diagram of a measurement device provided in an embodiment of the present disclosure;

FIG. 16 is a schematic diagram of a measurement device provided in an embodiment of the present disclosure;

FIG. 17 is a schematic diagram of a measurement device provided in an embodiment of the present disclosure;

FIG. 18 is a schematic diagram of a chip provided in an embodiment of the present disclosure.

### DETAILED DESCRIPTION

In order to better understand a measurement method disclosed in an embodiment of the present disclosure, a communication system to which an embodiment of the present disclosure is applicable is first described below.

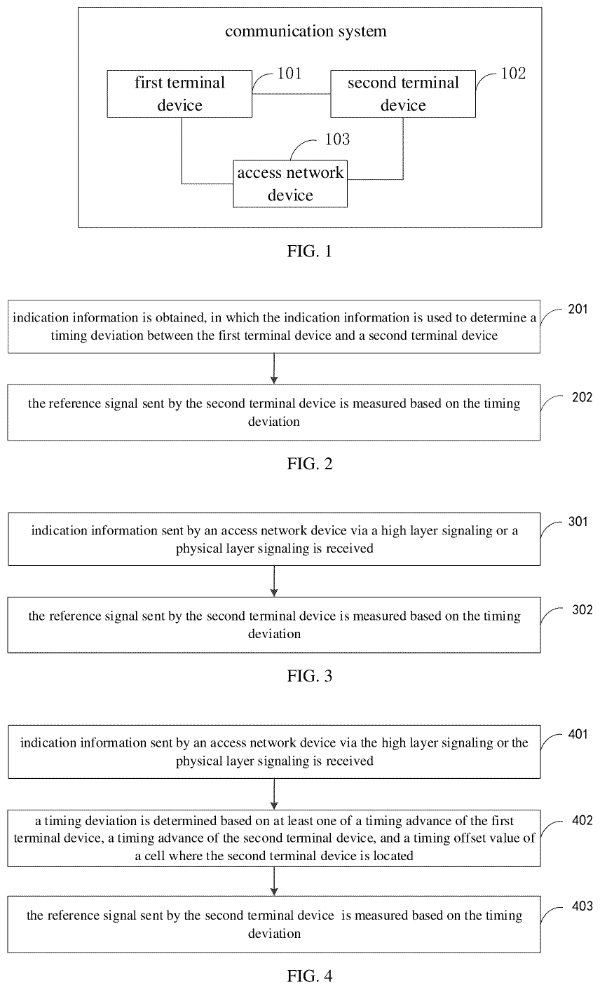

FIG. 1 is a schematic diagram of a communication system. The communication system may include, but is not limited to, an access network device and two terminal devices. The number and form of devices shown in FIG. 1 are only used as examples and do not constitute a limitation on the embodiments of the present disclosure. In actual applications, two or more access network devices and two or more terminal devices may be included. The communication system shown in FIG. 1 takes an access network device 103, a first terminal device 101, and a second terminal device 102 as an example.

It should be noted that the technical solutions of the embodiments of the present disclosure can be applied to various communication systems, such as long term evolution (LTE) system, fifth generation (5G) mobile communication system, 5G new radio (NR) system, or other future new mobile communication systems.

The access network device 103 in an embodiment of the present disclosure is an entity at the network side for transmitting or receiving signals. For example, the access network device 103 may be an evolved NodeB (eNB), a transmission reception point (TRP), a next generation NodeB (gNB) in an NR system, a base station in other future mobile communication systems, or an access node in a wireless fidelity (Wi-Fi) system. The embodiments of the present disclosure do not limit the specific technology and specific device form adopted by the network device. The network device provided in an embodiment of the present disclosure may be composed of a centralized unit (CU) and a distributed unit (DU), the CU may also be referred to as a control unit. The CU-DU structure may be used to split the protocol layer of the network device, such as a base station, and some functions of the protocol layers are placed in the CU for centralized control, and the remaining part or all functions of the protocol layers are distributed in the DU, and the DU is centrally controlled by the CU.

The first terminal device 101 and the second terminal device 102 in an embodiment of the present disclosure are an entity for receiving or transmitting signals on the user side, such as a mobile phone. The terminal device may also be referred to as a terminal, a user equipment (UE), a mobile station (MS), a mobile terminal device (MT), etc. The terminal device may be a car with communication function, a smart car, a mobile phone, a wearable device, a Pad, a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. An embodiment of the present disclosure does not limit the specific technology and specific device form adopted by the first terminal device and the second terminal device.

In the related art, taking the first terminal device as an example, the first terminal device 101 will monitor the transmission of the reference signal of the interfering terminal, that is, the second terminal device 102, according to the configuration information of the access network device 103, to measure the reference signal of the second terminal device 102. The reference signal is used to determine the degree of cross-interference between the first terminal device 101 and the second terminal device 102, and report the measurement result to the access network device 103, so that the access network device 103 may coordinate to avoid cross-interference between the terminals according to the measurement result. However, in the related art, due to different transmission distances, there is a timing deviation between the first terminal device 101 and the second terminal device 102. The timing deviation will cause the reference signal of the second terminal device 102 measured by the first terminal device 101 to have a difference of a set number of symbols, resulting in inaccurate measurement results. As an example, as shown in Table 1, due to the existence of the timing deviation, there is a data difference between the reference signal sent by the second terminal device and the reference signal received by the first terminal device.

TABLE 1

Reference signal

| | | | | | |
|---|---|---|---|---|---|
| First terminal device | D | D | D | S | U |
| Second terminal device | D | S | U | U | U |

Thus, the accuracy of reference signal measurement between terminal devices needs to be improved.

The present disclosure proposes a measurement method, which determines the timing deviation between the first terminal device and the second terminal device by obtained indication information, and coordinates the timing relationship between the first terminal device and the second terminal device based on the timing deviation to ensure the accuracy of the measurement of the reference signal sent by the first terminal device to the second terminal device.

It can be understood that the communication system described in an embodiment of the present disclosure is for more clearly illustrating the technical solution of an embodiment of the present disclosure, and does not constitute a limitation on the technical solution provided in an embodiment of the present disclosure. A person skilled in the art can know that with the evolution of the system architecture and the emergence of new business scenarios, the technical solution provided in an embodiment of the present disclosure is also applicable to similar technical problems.

The measurement method and the measurement device provided by the present disclosure are described in detail below with reference to the accompanying drawings.

FIG. 2 shows a flow chart of a measurement method. As shown in FIG. 2, the method is executed by the first terminal device, and may include but is not limited to the following steps.

Step 201: indication information is obtained, in which the indication information is used to determine a timing deviation between the first terminal device and a second terminal device.

The executor of an embodiment of the present disclosure is a first terminal device. There is interference between the first terminal device and the second terminal device. The first terminal device is used to measure a reference signal sent by the second terminal device. The reference signal may be used to determine the degree of interference between the terminal devices.

The timing deviation indicates the time deviation between the second terminal device that sends the reference signal and the first terminal device that measures the reference signal.

In one implementation, the first terminal device obtains indication information, in which the indication information carries a timing deviation, that is, the first terminal device may directly obtain the timing deviation, the timing deviation is determined based on at least one of a timing advance of the first terminal device, a timing advance of the second terminal device, and a timing offset value of the cell where the second terminal device is located.

In another implementation, the first terminal device obtains indication information, in which the indication information carries the timing advance of the second terminal device and/or the timing offset value of the cell where the second terminal device is located. As an implementation, the first terminal device may determine the timing deviation according to at least one of the timing advance of the first terminal device, the timing advance of the second terminal device, and the timing offset value of the cell where the second terminal device is located.

The timing advance of the first terminal device refers to the time advance determined by the access network device for the first terminal device to send data to the access network device in order to ensure the time synchronization of the terminal device sending data to the access network device.

The timing advance of the second terminal device refers to the time advance determined by the access network device for the second terminal device to send data to the access network device in order to ensure time synchronization of the terminal device sending data to the access network device.

The timing offset value of the cell where the second terminal device is located is usually a set value.

Step 202, the reference signal sent by the second terminal device is measured based on the timing deviation.

In an embodiment of the present disclosure, the reference signal sent by the second terminal device may be a channel sounding reference signal (SRS), the SRS includes at least one of a received signal strength indication (RSSI) and a reference signal receiving power (RSRP).

As an implementation method, there are one or more second terminal devices, and each second terminal device has a corresponding timing deviation. Therefore, the first terminal device adjusts the timing for the first terminal device to measure the reference signal sent by each second terminal device based on the timing deviation corresponding to each second terminal device, so as to measure the reference signal sent by each second terminal device.

In an embodiment of the present disclosure, the first terminal device adjusts the time for measuring the reference signal sent by each second terminal device based on the timing deviation, so that the time when each second terminal device sends the reference signal is synchronized with the time when the first terminal device receives the reference signal, thereby ensuring the accuracy of the reference signals sent by each second terminal device received by the first terminal device.

In summary, the indication information is obtained by the first terminal device, the timing deviation between the first terminal device and the second terminal device is determined based on the indication information, and the reference signal sent by the second terminal device is measured based on the timing deviation. This adjustment of the timing deviation between the first terminal device and the second terminal device is realized in the first terminal device, and coordination of the timing relationship between the first terminal device and the second terminal device is realized based on the timing deviation, so as to ensure the accuracy of the measurement of the reference signal sent by the first terminal device to the second terminal device.

FIG. 3 is a flow chart of a measurement method. It should be noted that the measurement method in an embodiment of the present disclosure is performed by the first terminal device. The method may be performed independently or in combination with any other embodiment of the present disclosure. As shown in FIG. 3, the method may include the following steps.

Step 301, indication information sent by an access network device via a high layer signaling or a physical layer signaling is received.

The high layer signaling includes Radio Resource Control (RRC) signaling, and physical layer signaling includes Medium Access Control (MAC) Control Element (CE) signaling.

In one implementation of an embodiment of the present disclosure, the indication information sent by the access network device via the high layer signaling or the physical layer signaling and received by the first terminal device carries a timing deviation, that is, the timing deviation is determined by the access network device. As an implementation, the timing deviation is determined by the access network device of the first terminal device based on at least one of the timing advance of the first terminal device, the timing advance of the second terminal device and the timing offset value of the cell where the second terminal device is located.

The timing advance of the first terminal device refers to the time advance determined by the access network device for the first terminal device to send data to the access network device in order to ensure the time synchronization of the terminal device sending data to the access network device.

The timing advance of the second terminal device refers to the time advance determined by the access network device for the second terminal device to send data to the access network device in order to ensure time synchronization of the terminal device sending data to the access network device.

The timing offset value of the cell where the second terminal device is located is usually a set value.

As an implementation, the timing advance of the second terminal device and the timing offset value of the cell where the second terminal device is located are obtained through interaction between the access network device of the first terminal device and the access network device of the second terminal device to be measured.

In an embodiment of the present disclosure, as an implementation for determining the timing deviation, the determination of the timing deviation satisfies the following relationship.

Timing deviation=T0+T1+T2, in which TO is the timing offset value of the cell where the second terminal device is located; T1 is the timing advance of the second terminal device; and T2 is the timing advance of the first terminal device.

As another implementation, the timing deviation is determined to satisfy the following relationship.

Timing deviation=T0+T1+T2−T3, in which T3 is the transmission delay between the first terminal device and the second terminal device.

Step 302, the reference signal sent by the second terminal device is measured based on the timing deviation.

Step 302 may refer to the explanation in the above-mentioned embodiment, and the principle is the same, which will not be repeated here.

In summary, by receiving indication information sent by an access network device via the high layer signaling or the physical layer signaling, the timing deviation between the first terminal device and the second terminal device is determined based on the indication information, and the reference signal sent by the second terminal device is measured based on the timing deviation, the timing deviation between the first terminal device and the second terminal device is adjusted in the first terminal device, and the timing relationship between the first terminal device and the second terminal device is coordinated based on the timing deviation to ensure the accuracy of the measurement of the reference signal sent by the first terminal device to the second terminal device.

FIG. 4 is a flow chart of a measurement method. It should be noted that the measurement method in an embodiment of the present disclosure is executed by the first terminal device, and the first terminal device calculates the timing deviation based on the indication information sent from the access network device. The method may be executed independently or in combination with any other embodiment of the present disclosure. As shown in FIG. 4, the method may include the following steps.

Step 401, indication information sent by an access network device via the high layer signaling or the physical layer signaling is received.

The high layer signaling includes the RRC signaling, and physical layer signaling includes MAC CE signaling.

The access network device may provide services for the first terminal device, such as a service base station for the first terminal device. In an embodiment of the present disclosure, the access network device that provides services for the first terminal device is referred to as the access network device of the first terminal device. Similarly, the access network device that provides services for the second terminal device is referred to as the access network device of the second terminal device.

In an embodiment of the present disclosure, the indication information sent by the access network device via the high layer signaling or the physical layer signaling and received by the first terminal device carries the timing advance of the second terminal device and/or the timing offset value of the cell where the second terminal device is located. The timing advance of the second terminal device and the timing offset value of the cell where the second terminal device is located are obtained through the interaction between the access network device of the first terminal device and the access network device of the second terminal device to be measured.

The timing advance of the second terminal device refers to the time advance determined by the access network device for the second terminal device to send data to the access network device in order to ensure the time synchronization of the terminal device sending data to the access network device.

The timing offset value of the cell where the second terminal device is located is usually a set value.

Step 402, a timing deviation is determined based on at least one of a timing advance of the first terminal device, a timing advance of the second terminal device, and a timing offset value of a cell where the second terminal device is located.

The timing advance of the first terminal device refers to the time advance determined by the access network device for the first terminal device to send data to the access network device in order to ensure the time synchronization of the terminal device sending data to the access network device.

In an embodiment of the present disclosure, the timing deviation is calculated by the first terminal device.

As an implementation, the determination of the timing deviation satisfies the following relationship.

Timing deviation=T0+T1+T2, in which TO is the timing offset value of the cell where the second terminal device is located; T1 is the timing advance of the second terminal device; and T2 is the timing advance of the first terminal device.

As another implementation, the timing deviation is determined to satisfy the following relationship.

Timing deviation=T0+T1+T2−T3, in which T3 is the transmission delay between the first terminal device and the second terminal device.

Step 403, the reference signal sent by the second terminal device is measured based on the timing deviation.

Step 402 may refer to the explanation in the above-mentioned embodiment, and the principle is the same, which will not be repeated here.

In summary, by receiving indication information sent by an access network device via the high layer signaling or the physical layer signaling, the timing deviation between the first terminal device and the second terminal device is determined based on the indication information, and the reference signal sent by the second terminal device is measured based on the timing deviation, the timing deviation between the first terminal device and the second terminal device is adjusted in the first terminal device, and the timing relationship between the first terminal device and the second terminal device is coordinated based on the timing deviation to ensure the accuracy of the measurement of the reference signal sent by the first terminal device to the second terminal device.

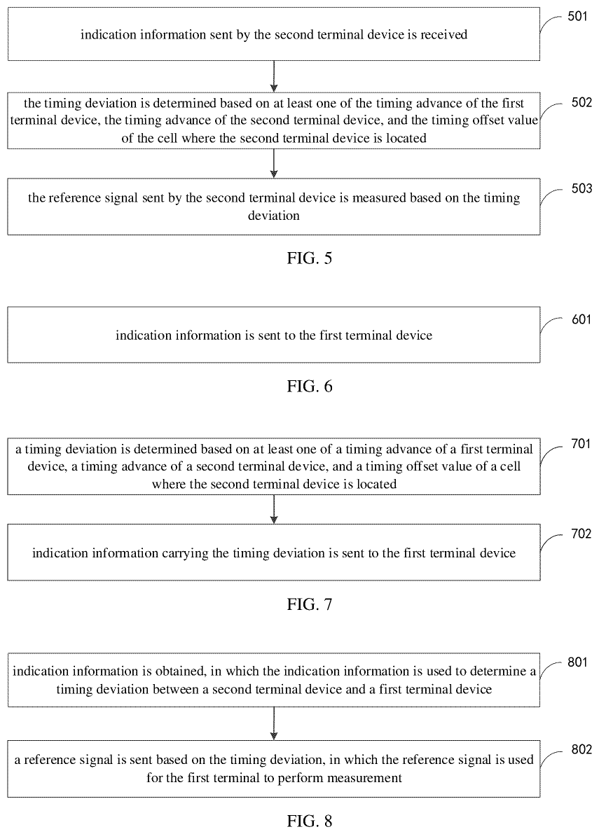

FIG. 5 is a flow chart of the measurement method. It should be noted that the measurement method in an embodiment of the present disclosure is performed by the first terminal device, which indicates that the indication information is obtained from the second terminal device. The method may be performed independently or in combination with any other embodiment of the present disclosure. As shown in FIG. 5, the method may include the following steps.

Step 501, indication information sent by the second terminal device is received.

The second terminal device is a terminal device that causes cross interference to the uplink and downlink transmission of the first terminal device. The indication information of the timing deviation between the first terminal device and the second terminal device is determined and sent by the second terminal device.

In an embodiment of the present disclosure, the indication information sent by the second terminal device and received by the first terminal device carries the timing advance of the second terminal device and/or the timing offset value of the cell where the second terminal device is located. The timing advance of the second terminal device and the timing offset value of the cell where the second terminal device is located are obtained through the interaction between the access network device of the first terminal device and the access network device of the second terminal device to be measured.

The timing advance of the second terminal device refers to the time advance determined by the access network device for the second terminal device to send data to the access network device in order to ensure the time synchronization of the terminal device sending data to the access network device.

The timing offset value of the cell where the second terminal device is located is usually a set value.

Step 502, the timing deviation is determined based on at least one of the timing advance of the first terminal device, the timing advance of the second terminal device, and the timing offset value of the cell where the second terminal device is located.

The timing advance of the first terminal device refers to the time advance determined by the access network device for the first terminal device to send data to the access network device in order to ensure the time synchronization of the terminal device sending data to the access network device.

As an implementation, the determination of the timing deviation satisfies the following relationship.

Timing deviation=T0+T1+T2, in which TO is the timing offset value of the cell where the second terminal device is located; T1 is the timing advance of the second terminal device; and T2 is the timing advance of the first terminal device.

As another implementation, the timing deviation is determined to satisfy the following relationship.

Timing deviation=T0+T1+T2−T3, in which T3 is the transmission delay between the first terminal device and the second terminal device.

Step 503: the reference signal sent by the second terminal device is measured based on the timing deviation.

Step 503 may refer to the explanation in the above embodiment, the principle is the same, and it will not be repeated here.

In summary, the indication information sent by the second terminal device is received by the first terminal device, the timing deviation between the first terminal device and the second terminal device is determined based on the indication information, and the reference signal sent by the second terminal device is measured based on the timing deviation, so as to adjust the timing deviation between the first terminal device and the second terminal device in the first terminal device, and coordinate the timing relationship between the first terminal device and the second terminal device based on the timing deviation to ensure the accuracy of the reference signal measurement sent by the first terminal device to the second terminal device. It should be noted that the indication information obtained from the second terminal device may also carry the timing deviation, that is, the timing deviation is determined by the second terminal device, the method for determining the timing deviation information may refer to the explanation in the aforementioned embodiment, the principle is the same, and it will not be repeated here. FIG. 6 is a flow chart of a measurement method. It should be noted that the measurement method in an embodiment of the present disclosure is executed by an access network device or a second terminal device. The method may be executed independently or in combination with any other embodiment of the present disclosure. As shown in FIG. 6, the method may include the following steps.

Step 601, indication information is sent to the first terminal device.

The indication information is used by the first terminal device to determine a timing deviation of the first terminal device relative to the second terminal device, and to measure a reference signal sent by the second terminal device based on the timing deviation.

The timing deviation indicates the time deviation between the second terminal device that sends the reference signal and the first terminal device that measures the reference signal.

In an embodiment of the present disclosure, an access network device sends indication information to a first terminal device, in which the access network device is an access network device that provides services to the first terminal device, that is, an access network device of the first terminal device.

In one implementation, the indication information sent by the access network device to the first terminal device carries a timing deviation, that is, the timing deviation is calculated by the access network device of the first terminal device. The timing deviation is determined by the access network device of the first terminal device based on at least one of the timing advance of the first terminal device, the timing advance of the second terminal device, and the timing offset value of the cell where the second terminal device is located.

In another implementation, the indication information sent by the access network device to the first terminal device carries the timing advance of the second terminal device and/or the timing offset value of the cell where the second terminal device is located, so that the first terminal device may determine the timing deviation based on at least one of the timing advance of the first terminal device, the timing advance of the second terminal device and the timing offset value of the cell where the second terminal device is located.

In an embodiment of the present disclosure, the access network device of the first terminal device interacts with the access network device of the second terminal device to obtain the timing advance value of the second terminal device and/or the timing offset value of the cell where the second terminal device is located.

In another embodiment of the present disclosure, the second terminal device sends indication information to the first terminal device, in which the second terminal device is a terminal device that interferes with the first terminal device.

In one implementation, the indication information sent by the second terminal device to the first terminal device carries information about the timing deviation, that is, the timing deviation is calculated by the second terminal device, so that the first terminal device may determine the timing deviation based on the obtained timing deviation information, in which the timing deviation is determined by the second terminal device based on at least one of the timing advance of the first terminal device, the timing advance of the second terminal device and the timing offset value of the cell where the second terminal device is located.

In another implementation, the indication information sent by the second terminal device to the first terminal device carries the timing advance of the second terminal device and/or the timing offset value of the cell where the second terminal device is located, so that the first terminal device may determine the timing deviation based on at least one of the timing advance of the first terminal device, the timing advance of the second terminal device and the timing offset value of the cell where the second terminal device is located.

It should be noted that the timing advance of the first terminal device refers to the time advance determined by the access network device for the first terminal device to send data to the access network device in order to ensure time synchronization of the terminal device sending data to the access network device.

The timing advance of the second terminal device refers to the time advance determined by the access network device for the second terminal device to send data to the access network device in order to ensure time synchronization of the terminal device sending data to the access network device.

The timing offset value of the cell where the second terminal device is located is usually a set value.

In summary, the indication information is sent to the first terminal device via the access network device or the second terminal device, so that the device on the first terminal determines the timing deviation between the first terminal device and the second terminal device based on the indication information, thereby adjusting the timing deviation between the first terminal device and the second terminal device in the first terminal device, and coordinating the timing relationship between the first terminal device and the second terminal device based on the timing deviation, so as to ensure the accuracy of the measurement of the reference signal sent by the first terminal device to the second terminal device.

FIG. 7 is a flow chart of a measurement method. It should be noted that the measurement method in an embodiment of the present disclosure is performed by the access network device and the second terminal device. The method may be performed independently or in combination with any other embodiment of the present disclosure. As shown in FIG. 7, the method may include the following steps.

Step 701, a timing deviation is determined based on at least one of a timing advance of a first terminal device, a timing advance of a second terminal device, and a timing offset value of a cell where the second terminal device is located.

The relevant explanations and descriptions of the access network device and the second terminal device are also applicable to this embodiment and will not be repeated here.

As an implementation, the timing deviation is determined to satisfy the following relationship.

Timing deviation=T0+T1+T2, in which TO is the timing offset value of the cell where the second terminal device is located; T1 is the timing advance of the second terminal device; and T2 is the timing advance of the first terminal device.

As another implementation, the timing deviation is also determined to satisfy the following relationship.

Timing deviation=T0+T1+T2−T3, in which T3 is the transmission delay between the first terminal device and the second terminal device.

Step 702, indication information carrying the timing deviation is sent to the first terminal device.

In an embodiment of the present disclosure, indication information carrying a timing deviation is sent to a first terminal device by an access network device or a second terminal device, in which the indication information is used by the first terminal device to determine a timing deviation of the first terminal device relative to the second terminal device, and to measure a reference signal sent by the second terminal device based on the timing deviation.

In one implementation of an embodiment of the present disclosure, there are one or more second terminal devices, and each second terminal device has a corresponding timing deviation, that is, each second terminal device that interferes with the first terminal device has a timing deviation with the first terminal device.

Therefore, the timing deviation information carried in the indication information includes the timing deviation information of the first terminal device relative to each second terminal device, so that the first terminal device measures the reference signal sent by each second terminal device based on the received timing deviation information of the first terminal device relative to each second terminal device, so as to improve the accuracy of the measurement of the reference signal sent by each second terminal device in the scenario where there are multiple second terminal devices.

In summary, indication information carrying the timing deviation is sent to the first terminal device by the access network device or the second terminal device, so that the device on the first terminal may obtain the timing deviation of the first terminal device relative to the second terminal device based on the indication information without the need for calculation by the first terminal device, thereby reducing the calculation burden of the first terminal device and achieving adjustment of the timing deviation between the first terminal device and the second terminal device in the first terminal device to ensure the accuracy of the measurement of the reference signal sent by the first terminal device to the second terminal device.

FIG. 8 is a flow chart of a measurement method. It should be noted that the measurement method in an embodiment of the present disclosure is performed by the second terminal device. The method may be performed independently or in combination with any other embodiment of the present disclosure. As shown in FIG. 8, the method may include the following steps.

Step 801, indication information is obtained, in which the indication information is used to determine a timing deviation between a second terminal device and a first terminal device.

The executor of an embodiment of the present disclosure is a second terminal device, the first terminal device is a terminal device that interferes with the second terminal device.

As an implementation, the indication information carries the timing advance of the first terminal device, in which the indication information may be sent by the first terminal device or sent by the access network device via a high layer signaling or a physical layer signaling. Thus, the second terminal device determines the timing deviation based on at least one of the timing advance of the first terminal device, the timing advance of the second terminal device, and the timing offset value of the cell where the second terminal device is located.

As another implementation, the indication information carries the timing deviation, in which the indication information may be sent by the first terminal device or sent by the access network device via the high layer signaling or the physical layer signaling. That is to say, the second terminal device may directly obtain the timing deviation from the indication information without the need for the calculation by the second terminal device, thereby reducing the calculation burden of the second terminal device.

Step 802, a reference signal is sent based on the timing deviation, in which the reference signal is used for the first terminal to perform measurement.

In an embodiment of the present disclosure, the second terminal device sends a reference signal based on the timing deviation so that the result obtained by the first terminal device measuring the reference signal sent by the second terminal device is more accurate. That is to say, the second terminal device sends the reference signal based on the timing deviation, so that there is no timing deviation between the reference signal sent by the second terminal device and the reference signal measured by the first terminal device, so that when the first terminal device measures the reference signal sent by the second terminal device, the accuracy of the measurement result is improved.

In summary, indication information is obtained by the second terminal device, in which the indication information is used to determine the timing deviation between the second terminal device and the first terminal device, and a reference signal is sent based on the timing deviation, in which the reference signal is used for measurement by the first terminal, so that there is no timing deviation between the reference signal sent by the second terminal device and the reference signal measured by the first terminal device, thereby adjusting the timing deviation between the first terminal device and the second terminal device in the second terminal device, so that when the first terminal device measures the reference signal sent by the second terminal device, the accuracy of the measurement result is improved.

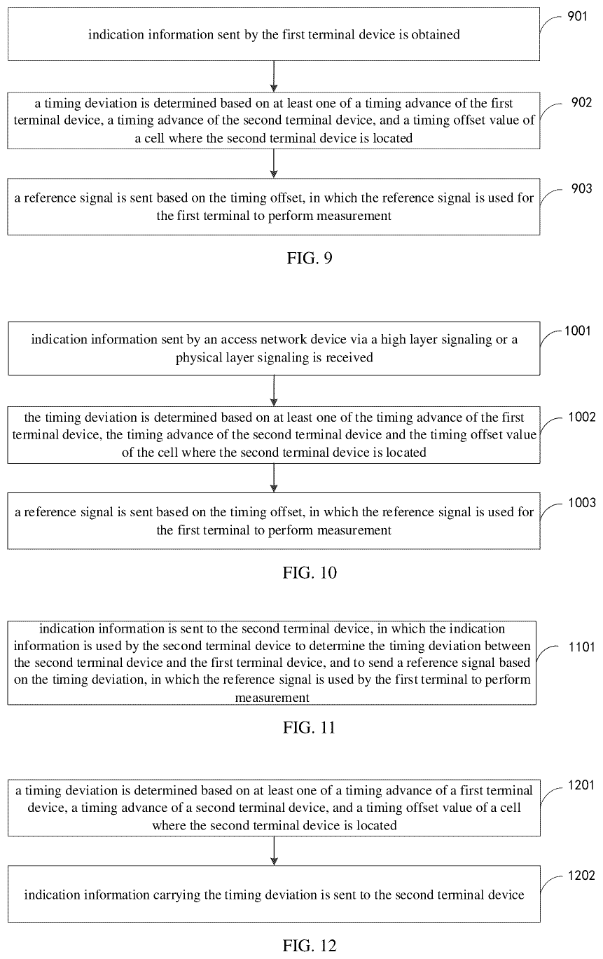

FIG. 9 is a flow chart of a measurement method. It should be noted that the measurement method in an embodiment of the present disclosure is performed by the second terminal device. The method may be performed independently or in combination with any other embodiment of the present disclosure. As shown in FIG. 9, the method may include the following steps.

Step 901, indication information sent by the first terminal device is obtained.

The indication information carries the timing advance of the first terminal device. The timing advance of the first terminal device refers to the time advance determined by the access network device for the first terminal device to send data to the access network device in order to ensure the time synchronization of the terminal device sending data to the access network device.

Step 902, a timing deviation is determined based on at least one of a timing advance of the first terminal device, a timing advance of the second terminal device, and a timing offset value of a cell where the second terminal device is located.

The timing advance of the second terminal device refers to the time advance determined by the access network device for the second terminal device to send data to the access network device in order to ensure the time synchronization of the terminal device sending data to the access network device.

The timing offset value of the cell where the second terminal device is located is usually a set value.

In an embodiment of the present disclosure, the timing deviation is calculated by the second terminal device and may be determined by the following implementation.

As an implementation, the determination of the timing deviation satisfies the following relationship.

Timing deviation=T0+T1+T2, in which TO is the timing offset value of the cell where the second terminal device is located; T1 is the timing advance of the second terminal device; and T2 is the timing advance of the first terminal device.

As another implementation, the timing deviation is determined to satisfy the following relationship.

Timing deviation=T0+T1+T2−T3, in which T3 is the transmission delay between the first terminal device and the second terminal device.

Step 903, a reference signal is sent based on the timing offset, in which the reference signal is used for the first terminal to perform measurement.

Specifically, reference may be made to the explanations in the aforementioned embodiments, the principles are the same and will not be repeated here.

In summary, the second terminal device obtains indication information carrying the timing advance of the first terminal device from the first terminal device, and the second terminal device determines the timing deviation based on at least one of the timing advance of the first terminal device, the timing advance of the second terminal device and the timing offset value of the cell where the second terminal device is located, and sends a reference signal based on the timing deviation, in which the reference signal is used for measurement by the first terminal, so that there is no timing deviation between the reference signal sent by the second terminal device and the reference signal measured by the first terminal device, thereby adjusting the timing deviation between the first terminal device and the second terminal device in the second terminal device, so that when the first terminal device measures the reference signal sent by the second terminal device, the measurement result has higher accuracy.

FIG. 10 is a flow chart of a measurement method. It should be noted that the measurement method in an embodiment of the present disclosure is performed by the second terminal device. The method may be performed independently or in combination with any other embodiment of the present disclosure. As shown in FIG. 10, the method may include the following steps.

Step 1001, indication information sent by an access network device via a high layer signaling or a physical layer signaling is received.

The high layer signaling includes RRC signaling, and the physical layer signaling includes MAC CE signaling.

The indication information carries the timing advance of the first terminal device. The timing advance of the first terminal device refers to the time advance determined by the access network device for the first terminal device to send data to the access network device in order to ensure the time synchronization of the terminal device sending data to the access network device.

Step 1002, the timing deviation is determined based on at least one of the timing advance of the first terminal device, the timing advance of the second terminal device and the timing offset value of the cell where the second terminal device is located.

The timing advance of the second terminal device refers to the time advance determined by the access network device for the second terminal device to send data to the access network device in order to ensure the time synchronization of the terminal device sending data to the access network device.

The timing offset value of the cell where the second terminal device is located is usually a set value.

In an embodiment of the present disclosure, the timing deviation is calculated by the second terminal device.

As an implementation, the determination of the timing deviation satisfies the following relationship.

Timing deviation=T0+T1+T2, in which TO is the timing offset value of the cell where the second terminal device is located; T1 is the timing advance of the second terminal device; and T2 is the timing advance of the first terminal device.

As another implementation, the timing deviation is determined to satisfy the following relationship.

Timing deviation=T0+T1+T2−T3, in which T3 is the transmission delay between the first terminal device and the second terminal device.

Step 1003, a reference signal is sent based on the timing offset, in which the reference signal is used for the first terminal to perform measurement.

The details may refer to the explanations in the aforementioned embodiments. The principles are the same and will not be repeated here.

In summary, the second terminal device obtains indication information carrying the timing advance of the first terminal device from the access network device, and the second terminal device determines the timing deviation based on at least one of the timing advance of the first terminal device, the timing advance of the second terminal device and the timing offset values of the cell where the second terminal device is located, and sends a reference signal based on the timing deviation, in which the reference signal is used for measurement by the first terminal, so that there is no timing deviation between the reference signal sent by the second terminal device and the reference signal measured by the first terminal device, thereby adjusting the timing deviation between the first terminal device and the second terminal device in the first terminal device, so that when the first terminal device measures the reference signal sent by the second terminal device, the measurement result has higher accuracy.

FIG. 11 is a flow chart of a measurement method. It should be noted that the measurement method in an embodiment of the present disclosure is performed by an access network device or a first terminal device. The method may be performed independently or in combination with any other embodiment of the present disclosure. As shown in FIG. 11, the method may include the following steps.

Step 1101, indication information is sent to the second terminal device, in which the indication information is used by the second terminal device to determine the timing deviation between the second terminal device and the first terminal device, and to send a reference signal based on the timing deviation, in which the reference signal is used by the first terminal to perform measurement.

The timing deviation indicates the time deviation between the second terminal device that sends the reference signal and the first terminal device that measures the reference signal.

In an embodiment of the present disclosure, an access network device sends indication information to a first terminal device, in which the access network device is an access network device that provides services to a second terminal device, and is referred to as an access network device of the second terminal device.

In one implementation, the indication information sent by the access network device to the second terminal device carries information about the timing deviation, that is, the timing deviation is calculated by the access network device of the second terminal device, so that the second terminal device may determine the timing deviation based on the obtained timing deviation information, in which the timing deviation is determined by the access network device of the second terminal device based on at least one of the timing advance of the first terminal device, the timing advance of the second terminal device and the timing offset value of the cell where the second terminal device is located.

In another implementation, the indication information sent by the access network device to the second terminal device carries the timing advance of the first terminal device, so that the second terminal device may determine the timing deviation based on at least one of the timing advance of the first terminal device, the timing advance of the second terminal device and the timing offset values of the cell where the second terminal device is located.

The access network device of the second terminal device interacts with the access network device of the first terminal device to obtain the timing advance of the first terminal device.

In another embodiment of the present disclosure, the first terminal device sends indication information to the second terminal device, in which the second terminal device is a terminal device that interferes with the first terminal device.

In one implementation, the indication information sent by the first terminal device to the second terminal device carries information about the timing deviation, that is, the timing deviation is calculated by the first terminal device, so that the second terminal device may determine the timing deviation based on the obtained timing deviation information, in which the timing deviation is determined by the first terminal device based on at least one of the timing advance of the first terminal device, the timing advance of the second terminal device and the timing offset value of the cell where the second terminal device is located.

In another implementation, the indication information sent by the first terminal device to the second terminal device carries the timing advance of the first terminal device, so that the first terminal device may determine the timing deviation based on at least one of the timing advance of the first terminal device, the timing advance of the second terminal device and the timing offset values of the cell where the second terminal device is located.

The timing advance of the first terminal device may be obtained through interaction between the first terminal device and an access network device of the first terminal device.

It should be noted that the timing advance of the first terminal device refers to the time advance determined by the access network device for the first terminal device to send data to the access network device in order to ensure time synchronization of the terminal device sending data to the access network device.

The timing advance of the second terminal device refers to the time advance determined by the access network device for the second terminal device to send data to the access network device in order to ensure time synchronization of the terminal device sending data to the access network device.

The timing offset value of the cell where the second terminal device is located is usually a set value.

In summary, indication information is sent to the second terminal device by the access network device or the first terminal device, in which the indication information is used by the second terminal device to determine the timing deviation between the second terminal device and the first terminal device, and a reference signal is sent based on the timing deviation, the reference signal is used for the first terminal to perform measurement, thereby adjusting the time for sending the reference signal based on the timing deviation at the second terminal device side, so that there is no timing deviation for the second terminal device relative to the first terminal device, thereby improving the measurement accuracy of the reference signal sent by the second terminal device by the first terminal device.

FIG. 12 is a flow chart of a measurement method. It should be noted that the measurement method in an embodiment of the present disclosure is performed by an access network device or a first terminal device. The method may be performed independently or in combination with any other embodiment of the present disclosure. As shown in FIG. 12, the method may include the following steps.

Step 1201, a timing deviation is determined based on at least one of a timing advance of a first terminal device, a timing advance of a second terminal device, and a timing offset value of a cell where the second terminal device is located.

In an embodiment of the present disclosure, the access network device or the first terminal device determines the timing deviation based on at least one of the timing advance of the first terminal device, the timing advance of the second terminal device, and the timing offset value of the cell where the second terminal device is located, that is, the access network device or the first terminal device determines the timing deviation.

The method for determining the timing deviation may refer to the explanation in the above-mentioned embodiment, the principle is the same, and it will not be repeated here.

Step 1202, indication information carrying the timing deviation is sent to the second terminal device.

Specifically, reference may be made to the explanations in the aforementioned embodiments, the principles are the same and will not be repeated here.

In summary, indication information carrying the timing deviation is sent to the second terminal device by the access network device or the first terminal device, so that the second terminal device sends a reference signal based on the timing deviation, in which the reference signal is used for measurement by the first terminal, thereby adjusting the time for sending the reference signal based on the timing deviation at the second terminal device side, so that there is no timing deviation for the second terminal device relative to the first terminal device, thereby improving the measurement accuracy of the reference signal sent by the second terminal device by the first terminal device.

In the above embodiments provided by the present disclosure, the method provided by an embodiment of the present disclosure is introduced from the perspectives of the first terminal device, the second terminal device and the access network device. In order to implement the functions in the method provided by the above embodiments of the present disclosure, the access network device, the second terminal device and the first terminal device may include a hardware structure and a software module, and implement the above functions in the form of a hardware structure, a software module, or a hardware structure plus a software module. A certain function of the above functions may be executed in the form of a hardware structure, a software module, or a hardware structure plus a software module.

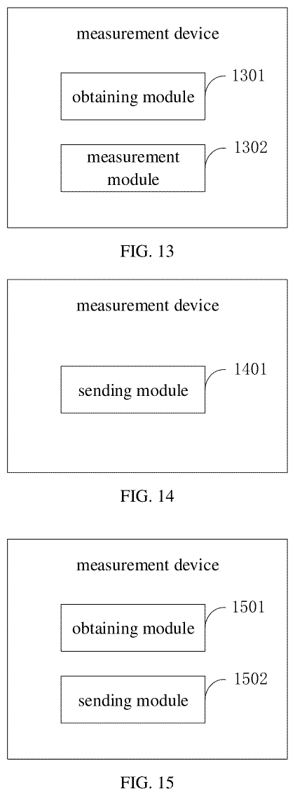

FIG. 13 is a schematic diagram of a measurement device. The device may be a first terminal device, or a device arranged in the first terminal device, or a device that may be used in conjunction with the first terminal device. As shown in FIG. 13, the device includes an obtaining module 1301 and a measurement module 1302.

The obtaining module 1301 is configured to obtain indication information, in which the indication information is used to determine a timing deviation between the first terminal device and a second terminal device.

The measurement module 1302 is configured to measure a reference signal sent by the second terminal device based on the timing deviation.

As an implementation, the indication information carries the timing deviation.

The timing deviation is determined based on at least one of a timing advance of the first terminal device, a timing advance of the second terminal device, or a timing offset value of a cell where the second terminal device is located.

As an implementation, the indication information carries a timing advance value of the second terminal device and/or a timing offset value of a cell where the second terminal device is located.

The device also includes:
a determination module, configured to determine the timing deviation based on at least one of a timing advance of the first terminal device, the timing advance of the second terminal device, or the timing offset value of the cell where the second terminal device is located.

As an implementation, there are one or more second terminal devices, and each second terminal device has a corresponding timing deviation.

The measurement module 1302 is configured to measure a reference signal sent by the each second terminal device based on the corresponding timing deviation of the each second terminal device

As an implementation, the obtaining module 1301 is specifically configured to:
receive the indication information sent by an access network device via a high layer signaling or a physical layer signaling; and/or,
receive the indication information sent by the second terminal device.

It should be noted that the above-mentioned measurement device provided in an embodiment of the present disclosure may implement all the method steps implemented in the above-mentioned method embodiment, and may achieve the same technical effect. The parts and beneficial effects of this embodiment that are the same as those in the method embodiment will not be described in detail here.

FIG. 14 is a schematic diagram of a measurement device. The device may be an access network device or a second terminal device, or may be a device arranged in the access network device or the second terminal device, or may be a device that may be used in conjunction with the access network device or the second terminal device. As shown in FIG. 14, the device includes a sending module 1401.

The sending module 1401 is configured to send indication information to a first terminal device.

The indication information is used by the first terminal device to determine a timing deviation between the first terminal device and the second terminal device, and to measure a reference signal sent by the second terminal device based on the timing deviation.

Further, as an implementation, the indication information carries information of the timing deviation.

The device also includes:
a determination module, configured to determine a timing deviation based on at least one of a timing advance of the first terminal device, a timing advance of the second terminal device, or a timing offset value of a cell where the second terminal device is located.

As an implementation, the indication information carries a timing advance value of the second terminal device and/or a timing offset value of a cell where the second terminal device is located.

The indication information is used by the first terminal device to determine the timing deviation based on at least one of the timing advance of the first terminal device, the timing advance of the second terminal device and the timing offset value of the cell where the second terminal device is located.

As an implementation, there are one or more second terminal devices, and each second terminal device has a corresponding timing deviation.

It should be noted here that the above-mentioned measurement device provided in an embodiment of the present disclosure may implement all the method steps implemented in the above-mentioned method embodiment, and may achieve the same technical effect. The parts and beneficial effects of this embodiment that are the same as those in the method embodiment will not be described in detail here.

FIG. 15 is a schematic diagram of a measurement device. The device may be a second terminal device, or a device arranged in the second terminal device, or a device that may be used in conjunction with the second terminal device. As shown in FIG. 15, the device includes an obtaining module 1501 and a sending module 1502.

The obtaining module 1501 is configured to obtain indication information, in which the indication information is used to determine a timing deviation between the second terminal device and a first terminal device;

The sending module 1502 is configured to send a reference signal based on the timing offset, in which the reference signal is used for the first terminal to perform measurement.

Further, as an implementation, the indication information carries a timing advance of the first terminal device.

The device also includes:
a determination module, configured to determine the timing deviation based on at least one of the timing advance of the first terminal device, a timing advance of the second terminal device, or a timing offset value of a cell where the second terminal device is located.

As an implementation, the indication information carries the timing deviation.

As an implementation, the obtaining module 1501 is specifically configured to:
receive the indication information sent by the first terminal device; or,
receive the indication information sent by an access network device via a high layer signaling or a physical layer signaling.

It should be noted here that the above-mentioned measurement device provided in an embodiment of the present disclosure may implement all the method steps implemented in the above-mentioned method embodiment, and may achieve the same technical effect. The parts and beneficial effects of this embodiment that are the same as those in the method embodiment will not be described in detail here.

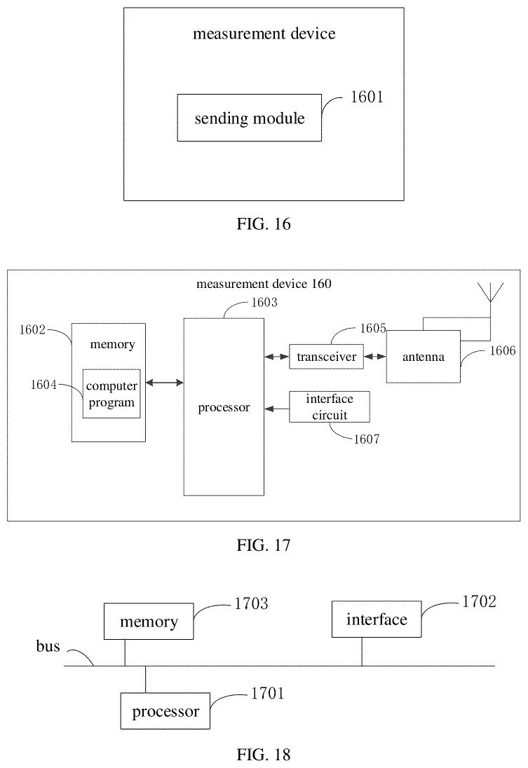

FIG. 16 is a schematic diagram of a measurement device. The device may be an access network device or a first terminal device, or may be a device arranged in the access network device or the first terminal device, or may be a device that may be used in conjunction with the access network device or the first terminal device. As shown in FIG. 16, the device includes a sending module 1601.

The sending module 1601 is configured to send indication information to a second terminal device.

The indication information is used by the second terminal device to determine a timing deviation between the second terminal device and the first terminal device, and to send a reference signal based on the timing deviation, in which the reference signal is used by the first terminal device for measurement.

Further, as an implementation, the indication information carries a timing advance of the first terminal device.

The timing deviation is determined by the second terminal device based on at least one of the timing advance of the first terminal device, a timing advance of the second terminal device or a timing offset value of a cell where the second terminal device is located.

As an implementation, the indication information carries the timing deviation.

The device further includes a determination module.

The determination module is configured to determine the timing deviation based on at least one of a timing advance of the first terminal device, a timing advance of the second terminal device, or a timing offset value of a cell where the second terminal device is located.

It should be noted that the above-mentioned measurement device provided in an embodiment of the present disclosure may implement all the method steps implemented in the above-mentioned method embodiment, and may achieve the same technical effect. The parts and beneficial effects of this embodiment that are the same as those in the method embodiment will not be described in detail here.

In order to implement the above embodiments, an embodiment of the present disclosure also provides a communication device, including: a processor and a memory, the memory store a computer program, and the processor executes the computer program stored in the memory so that the device executes the method shown in the embodiments of FIGS. 2 to 5.

In order to implement the above embodiments, an embodiment of the present disclosure also provides a communication device, including: a processor and a memory, the memory store a computer program, and the processor executes the computer program stored in the memory so that the device executes the method shown in the embodiments of FIGS. 6 and 7.

In order to implement the above embodiments, an embodiment of the present disclosure also provides a communication device, including: a processor and a memory, the memory store a computer program, and the processor executes the computer program stored in the memory so that the device executes the method shown in the embodiments of FIGS. 8 to 10.

In order to implement the above embodiments, an embodiment of the present disclosure also provides a communication device, including: a processor and a memory, the memory store a computer program, and the processor executes the computer program stored in the memory so that the device executes the method shown in the embodiments of FIGS. 11 and 12.

In order to implement the above embodiments, an embodiment of the present disclosure also provides a communication device, including: a processor and an interface circuit, the interface circuit is used to receive code instructions and transmit the code instructions to the processor, and the processor is used to run the code instructions to perform the methods shown in the embodiments of FIGS. 2 to 5.

In order to implement the above embodiments, an embodiment of the present disclosure also provides a communication device, including: a processor and an interface circuit, the interface circuit is used to receive code instructions and transmit the code instructions to the processor, and the processor is used to run the code instructions to perform the methods shown in the embodiments of FIGS. 6 and 7.

In order to implement the above-mentioned embodiments, an embodiment of the present disclosure also provides a communication device, including: a processor and an interface circuit, the interface circuit is used to receive code instructions and transmit the code instructions to the processor, and the processor is used to run the code instructions to perform the methods shown in the embodiments of FIGS. 8 to 10.

In order to implement the above embodiments, an embodiment of the present disclosure also provides a communication device, including: a processor and an interface circuit, the interface circuit is used to receive code instructions and transmit the code instructions to the processor, and the processor is used to run the code instructions to perform the methods shown in the embodiments of FIGS. 11 and 12.

FIG. 17 is a schematic diagram of a measurement device. The measurement device 160 may be a first terminal device, a second terminal device or an access network device, or a chip, a chip system, or a processor that supports the access network device to implement the above method, or a chip, a chip system, or a processor that supports the terminal device to implement the above method. The device may be used to implement the method described in the above method embodiment, and the details may be referred to the description in the above method embodiment.

The measurement device 160 may include one or more processors 1603. The processor 1603 may be a general-purpose processor or a dedicated processor, etc. For example, it may be a baseband processor or a central processing unit. The baseband processor may be used to process the communication protocol and communication data, and the central processing unit may be used to control the measurement device (such as a base station, a baseband chip, a terminal device, a terminal device chip, a DU or a CU, etc.), to execute a computer program, and process the data of the computer program.

In some embodiments, the measurement device 160 may further include one or more memories 1602, on which a computer program 1604 may be stored, and the processor 1603 executes the computer program 1604, so that the measurement device 160 performs the method described in the above method embodiment. In some embodiments, data may also be stored in the memory 1602. The testing device 160 and the memory 1602 may be provided separately or integrated together.

In some embodiments, the measurement device 160 may further include a transceiver 1605 and an antenna 1606. The transceiver 1605 may be referred to as a transceiving unit, a transceiver, or a transceiving circuit, etc., and is used to implement a transceiving function. The transceiver 1605 may include a receiver and a transmitter, the receiver may be referred to as a receiver or a receiving circuit, etc., and is used to implement a receiving function; the transmitter may be referred to as a transmitter or a transmitting circuit, etc., and is used to implement a transmitting function.

In some embodiments, the measurement device 160 may further include one or more interface circuits 1607. The interface circuit 1607 is used to receive code instructions and transmit the code instructions to the processor 1603. The processor 1603 runs the code instructions to enable the measurement device 160 to execute the method described in the above method embodiment.

In one implementation, the processor 1603 may include a transceiver for implementing the receiving and sending functions. For example, the transceiver may be a transceiving circuit, an interface, or an interface circuit. The transceiving circuit, interface, or interface circuit for implementing the receiving and sending functions may be separate or integrated. The above-mentioned transceiving circuit, interface, or interface circuit may be used for reading and writing code/data, or the above-mentioned transceiving circuit, interface, or interface circuit may be used for transmitting or delivering signals.

In one implementation, the processor 1603 may store a computer program 1604, the processor 1603 executes the computer program 1604 and enables the measurement device 160 to execute the method described in the above method embodiment. The computer program 1604 may be fixed in the processor 1603, in which case the processor 1603 may be implemented by hardware.

In one implementation, the measurement device 160 may include a circuit that may implement the functions of sending, receiving, or communicating in the aforementioned method embodiment. The processor and transceiver described in the present disclosure may be implemented in an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The measurement in the above embodiment description may be performed by a first terminal device, a second terminal device or an access network device, but the scope of the measurement device described in the present disclosure is not limited thereto, and the structure of the measurement device may not be limited by FIGS. 13-15. The measurement device may be an independent device or may be part of a larger device. For example, the measurement device may be:
(1) an independent integrated circuit IC, or a chip, or a chip system or a subsystem;
(2) a collection of one or more ICs, for example, including a storage component for storing data or computer programs;
(3) ASIC, such as modem;
(4) a modules that may be embedded in other devices;
(5) a receiver, a terminal device, an intelligent terminal device, a cellular phone,
a wireless device, a handheld device, a mobile unit, a vehicle-mounted device, an access network device, a cloud device, an artificial intelligence device, etc.;
(6) others.

In the case where the measurement device may be a chip or a chip system, reference may be made to the schematic diagram of the chip structure shown in FIG. 18. The chip shown in FIG. 18 includes a processor 1701 and an interface 1702. The number of processors 1701 may be one or more, and the number of interfaces 1702 may be multiple.

The chip is used to implement the function of the first terminal device in an embodiment of the present disclosure.

The interface 1702 is configured to receive the code instructions and transmit the code instructions to the processor.

The processor 1701 is used to run code instructions to execute the methods shown in FIGS. 2 to 5.

The chip is used to implement the functions of the access network device and the second terminal device in an embodiment of the present disclosure.

The interface 1702 is configured to receive the code instructions and transmit the code instructions to the processor.

The processor 1701 is configured to run code instructions to execute the methods shown in FIG. 6 and FIG. 7.

The chip is used to implement the function of the second terminal device in an embodiment of the present disclosure.

The interface 1702 is configured to receive the code instructions and transmit the code instructions to the processor.

The processor 1701 is used to run code instructions to execute the method shown in FIGS. 8 to 10.

The chip is used to implement the functions of the access network device and the first terminal device in an embodiment of the present disclosure.

The interface 1702 is configured to receive the code instructions and transmit the code instructions to the processor.

The processor 1701 is used to run code instructions to execute the method shown in FIGS. 11 and 12.

In some embodiments, the chip further includes a memory 1703, and the memory 1703 is used to store necessary computer programs and data.

A person skilled in the art may also understand that the various illustrative logical blocks and steps listed in the embodiments of the present disclosure may be implemented by electronic hardware, computer software, or a combination thereof. Whether such functions are implemented by hardware or software depends on the specific application and the design requirements of the entire system. A person skilled in the art may use various methods to implement the functions described for each specific application, but such implementation should not be understood as beyond the protection scope of the embodiments of the present disclosure.

The present disclosure also provides a readable storage medium having instructions stored thereon, the instructions are executed by a computer to implement the functions of any of the above method embodiments.

The present disclosure also provides a computer program product, which implements the functions of any of the above method embodiments when executed by a computer.

In the above embodiments, it can be implemented in whole or in part by software, hardware, firmware or any combination thereof. When implemented by software, it can be implemented in whole or in part in the form of a computer program product. The computer program product includes one or more computer programs. When the computer program is loaded and executed on a computer, the process or function described in the embodiment of the present disclosure is generated in whole or in part. The computer can be a general-purpose computer, a special-purpose computer, a computer network, or other programmable device. The computer program can be stored in a computer readable storage medium, or transmitted from one computer readable storage medium to another computer readable storage medium. For example, the computer program can be transmitted from a website, computer, server or data center by wired (e.g., coaxial cable, optical fiber, digital subscriber line (DSL)) or wireless (e.g., infrared, wireless, microwave, etc.) mode to another website, computer, server or data center. The computer readable storage medium can be any available medium that can be accessed by a computer or a data storage device such as a server or data center that includes one or more available medium. The available medium may be a magnetic medium (e.g., a floppy disk, a hard disk, a magnetic tape), an optical medium (e.g., a digital video disc (DVD)), or a semiconductor medium (e.g., a solid state disk (SSD)).

A person skilled in the art can understand that the various numbers such as first and second in the present disclosure are only used for distinction and convenience of description and are not used to limit the scope of the embodiments of the present disclosure, and also indicate the order of precedence.

At least one in the present disclosure may also be described as one or more, and a plurality may be two, three, four or more, which is not limited in the present disclosure. In the embodiments of the present disclosure, for a technical feature, the technical features in the technical feature are distinguished by “first”, “second”, “third”, “A”, “B”, “C” and “D”, etc., and there is no order of precedence or size between the technical features described by the “first”, “second”, “third”, “A”, “B”, “C” and “D”.

The corresponding relationships shown in the tables in the present disclosure can be configured or predefined. The values of the information in each table are only examples and can be configured as other values, which are not limited by the present disclosure. When configuring the corresponding relationship between the information and each parameter, it is not necessarily required to configure all the corresponding relationships illustrated in each table. For example, in the table in the present disclosure, the corresponding relationships shown in some rows may not be configured. For another example, appropriate deformation adjustments can be made based on the above table, such as splitting, merging, etc. The names of the parameters shown in the titles of the above tables can also use other names that can be understood by the communication device, and the values or representations of the parameters can also be other values or representations that can be understood by the communication device. When implementing the above tables, other data structures can also be used, such as arrays, queues, containers, stacks, linear lists, pointers, linked lists, trees, graphs, structures, classes, heaps, hash tables.

The predefined in the present disclosure may be understood as defined, predefined, stored, pre-stored, pre-negotiated, pre-configured, solidified, or pre-burned.

A person skilled in the art will appreciate that the units and algorithm steps of each example described in conjunction with the embodiments of the present disclosure can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of this disclosure.

A person skilled in the art can clearly understand that, for the convenience and brevity of description, the specific working processes of the systems, devices and units described above can refer to the corresponding processes in the aforementioned method embodiments and will not be repeated here.

The above is only a specific embodiment of the present disclosure, but the protection scope of the present disclosure is not limited thereto. A person skilled in the art who is familiar with the technical field can easily think of changes or substitutions within the technical scope in the present disclosure, which should be included in the protection scope of the present disclosure. Therefore, the protection scope of the present disclosure should be based on the protection scope of the claims.

1. A measurement method, performed by a first terminal device, comprising:
obtaining indication information, wherein the indication information is used to determine a timing deviation between the first terminal device and a second terminal device; and
measuring a reference signal sent by the second terminal device based on the timing deviation.

2. The measurement method according to claim 1, wherein:
the indication information carries the timing deviation;
the timing deviation is determined based on at least one of a timing advance of the first terminal device, a timing advance of the second terminal device, or a timing offset value of a cell where the second terminal device is located.

3. The measurement method according to claim 1, wherein:
the indication information carries at least one of a timing advance of the second terminal device or a timing offset value of a cell where the second terminal device is located; and
the method further comprises:
determining the timing deviation based on at least one of a timing advance of the first terminal device, the timing advance of the second terminal device, or the timing offset value of the cell where the second terminal device is located.

4. The measurement method according to claim 1, wherein there are one or more second terminal devices, and each second terminal device has a corresponding timing deviation;
measuring the reference signal sent by the second terminal device based on the timing deviation comprises:
measuring a reference signal sent by the each second terminal device based on the corresponding timing deviation of the each second terminal device.

5. The measurement method according to claim 1, wherein obtaining the indication information comprises:
receiving the indication information sent by an access network device via a high layer signaling or a physical layer signaling; and/or
receiving the indication information sent by the second terminal device.

6.-9. (canceled)

10. A measurement method, performed by a second terminal device, comprising:
obtaining indication information, wherein the indication information is used to determine a timing deviation between the second terminal device and a first terminal device;
sending a reference signal based on the timing deviation, wherein the reference signal is used for the first terminal to perform measurement.

11. The measurement method according to claim 10, wherein the indication information carries a timing advance of the first terminal device; and
the measurement method further comprises:
determining the timing deviation based on at least one of the timing advance of the first terminal device, a timing advance of the second terminal device, or a timing offset value of a cell where the second terminal device is located.

12. The measurement method according to claim 10, wherein the indication information carries the timing deviation.

13. The measurement method according to claim 10, wherein obtaining the indication information comprises:
receiving the indication information sent by the first terminal device; or,
receiving the indication information sent by an access network device via a high layer signaling or a physical layer signaling.

14.-20. (canceled)

21. A communication device, comprising a processor and a memory, wherein the memory stores a computer program, and the processor executes the computer program stored in the memory to perform the method according to claim 1.

22. (canceled)

23. A communication device, comprising a processor and a memory, wherein the memory stores a computer program, and the processor executes the computer program stored in the memory to perform the method according to claim 10,

24. (canceled)

25. A communication device, comprising: a processor and an interface circuit; wherein:
the interface circuit is configured to receive code instructions and transmit the code instructions to the processor; and
the processor is configured to run the code instructions to perform the method according to claim 1.

26. (canceled)

27. A communication device, comprising: a processor and an interface circuit; wherein
the interface circuit is configured to receive code instructions and transmit the code instructions to the processor; and
the processor is configured to run the code instructions to perform the method according to claim 10.

28. (canceled)

29. A non-transitory computer readable storage medium storing instructions, wherein the instructions are executed to implement the method according to claim 1.

30. (canceled)

31. A non-transitory computer readable storage medium storing instructions, wherein the instructions are executed to implement the method according to claim 1.

32. (canceled)
